(19) United States
(12) Patent Application Publication
(10) Pub. No.: US 2024/0242064 A1
(43) Pub. Date: Jul. 18, 2024

(54) DEVICE AND METHOD FOR AI NEURAL NETWORK SPEED ENHANCEMENT BY IMPLEMENTING NEURAL NETWORK ARCHITECTURE WITH PARTIAL CONVOLUTION

(71) Applicant: The Hong Kong University of Science and Technology, Hong Kong (CN)

(72) Inventors: Shueng Han Gary CHAN, Hong Kong (CN); Jierun CHEN, Hong Kong (CN)

(21) Appl. No.: 18/411,052

(22) Filed: Jan. 12, 2024

Related U.S. Application Data
(60) Provisional application No. 63/479,737, filed on Jan. 13, 2023.

(51) Int. Cl. G06N 3/0464

(52) U.S. Cl. CPC G06N 3/0464

(57) ABSTRACT

A device for employing an efficient neural network architecture through partial convolution is provided, including a fast network module, a data input module, and an outcome module. A fast neural network including multiple fast neural network blocks with at least one PConv layer and at least two PWConv layers are integrated in the fast network module. The data input module is responsible for loading and providing input data to the fast network module. The PConv layer is applied for partial convolution of the input data with achieving standard convolution operations on partial channels while preserving other channels unaffected and selectively convolves only a portion of input channels by leveraging redundant information in feature maps. The two PWConv layers following the PConv layer are configured to transform and integrate features. The outcome module is configured to receive results generated by the fast network module.

### TECHNICAL FIELD

The present invention relates to techniques of enhancing speed performance of artificial intelligence (AI) neural networks by implementing an efficient neural network architecture with partial convolution.

### BACKGROUND

Neural networks have witnessed significant advancements in various computer vision tasks, including image classification, detection, and segmentation. Despite their remarkable performance across diverse applications, there is a growing emphasis on developing fast neural networks characterized by low latency and high throughput. This pursuit of speed is driven by the desire for enhanced user experiences, prompt responses, and considerations for safety.

To achieve speed in neural networks, rather than relying on increasingly expensive computing devices, researchers and practitioners aim to design cost-effective solutions with reduced computational complexity, often quantified by the number of floating-point operations (FLOPs). For example, mobileNets, ShuffleNets, and GhostNet, among others, leverage the depthwise convolution (DWConv) and/or group convolution (GConv) to extract spatial features. However, these approaches, while successful in reducing FLOPs, often incur the drawback of heightened memory access. MicroNet takes a different approach by decomposing and sparsifying the network to achieve extremely low FLOPs. Despite improvements in FLOPs, this method encounters challenges related to inefficient fragmented computation. Additionally, networks employing these techniques often involve supplementary data manipulations, such as concatenation, shuffling, and pooling, which contribute significantly to the runtime, especially in smaller models.

Beyond conventional convolutional neural networks (CNNs), there is a rising interest in optimizing the size and speed of vision transformers (ViTs) and multilayer perceptrons (MLPs). MobileViTs and MobileFormer, for instance, reduce computational complexity by integrating DWConv with a modified attention mechanism. However, these models still face challenges associated with DWConv and may require specialized hardware support for the modified attention mechanism. The use of advanced yet time-consuming normalization and activation layers further poses potential limitations to their speed on various devices.

All these challenges collectively pose a fundamental question: are these so-called “fast” neural networks truly fast? To address this question, it is investigated that the correlation between latency and floating-point operations (FLOPs), expressed by the equation:

$$Latency = \frac{FLOPs}{FLOPS} … \qquad ( 1 )$$

Here, FLOPS represents floating-point operations per second and serves as a metric for effective computational speed. Despite numerous efforts to reduce FLOPs, there is a tendency to overlook the simultaneous optimization of FLOPS to achieve genuinely low latency.

To gain deeper insights, FLOPS of some of typical neural networks have been compared, and it is found that many existing neural networks exhibit low FLOPS, generally falling below the benchmark set by the popular ResNet50. However, these purportedly “fast” neural networks do not demonstrate a proportional increase in actual speed. The reduction in FLOPs does not necessarily translate into a significant reduction in latency. In some instances, there is no improvement, and it may even result in worse latency. It is noteworthy that this discrepancy between FLOPs and latency has been acknowledged in prior studies but remains partially unresolved, often attributed to the use of DWConv/GConv and various data manipulations with low FLOPS, leaving limited alternatives available.

Therefore, there is a need for solutions to chase higher FLOPS and to achieve genuinely low latency that can significantly enhance the performance of faster neural networks.

### SUMMARY OF INVENTION

It is an objective of the present invention to provide a device and a method to address the aforementioned shortcomings and unmet needs in the state of the art.

In accordance with a first aspect of the present invention, a device for enhancing speed performance of AI neural networks by implementing an efficient neural network architecture with partial convolution is provided. The device comprises a fast network module, a data input module, and an outcome module. A fast neural network comprising multiple fast neural network blocks with at least one partial convolution (PConv) layer and at least two pointwise convolution (PWConv) layers are integrated in the fast network module. The data input module is responsible for loading and providing input data to the fast network module, in which the PConv layer in each of the fast neural network blocks is applied for partial convolution of the input data with achieving standard convolution operations on partial channels while preserving other channels unaffected and selectively convolves only a portion of input channels by leveraging redundant information in feature maps. The two PWConv layers following the PConv layer in each of the fast neural network blocks are configured to transform and integrate features output from the PConv layer. The outcome module is configured to receive results generated by the fast network module for storage or record.

In accordance with a second aspect of the present invention, a method for enhancing speed performance of AI neural networks by implementing an efficient neural network architecture with partial convolution is provided. The method comprises the process steps: loading and providing input data, by a data input module, to a fast network module, wherein the fast neural network comprises multiple fast neural network blocks with at least one partial convolution (PConv) layer and at least two pointwise convolution (PWConv) layers; applying the PConv layer in each of the fast neural network blocks for partial convolution of the input data with achieving standard convolution operations on partial channels while preserving other channels unaffected, which comprises selectively convolving only a portion of input channels by leveraging redundant information in feature maps using the PConv layer; transforming and integrating features output from the PConv layer by using the two PWConv layers following the PConv layer in each of the fast neural network blocks; receiving, by an outcome module, results generated by the fast network module for storage or record.

The devices and the methods of the present invention aim to address the aforesaid shortcomings in the current state of the art by introducing a simple, fast, and efficient operator that maintains high FLOPS while reducing overall computational complexity. The novel approach provided by the present invention is arrived by examining the current operators, particularly DWConv, with focus on computational speed-FLOPS. Through this examination, it is identified that frequent memory access as the primary cause of low FLOPS and propose a novel solution: partial convolution (PConv). PConv serves as a competitive alternative by simultaneously reducing memory access and computational redundancy. The design of PConv leverages redundancy within feature maps, applying a regular convolution (Conv) to only a portion of input channels while leaving the rest untouched. PConv inherently achieves lower FLOPs than regular Conv and higher FLOPS than DWConv/GConv, effectively utilizing on-device computational capacity. Empirical validation in later sections confirms PConv's efficacy in spatial feature extraction.

Additionally, a novel module is provided with introducing FasterNet therein, which is a network primarily built on PConv, for serving as a new family of networks designed for high-speed performance across various devices. FasterNet achieves state-of-the-art results in classification, detection, and segmentation tasks, boasting significantly lower latency and higher throughput. For instance, the tiny FasterNet-T0 outperforms MobileViT-XXS by 2.1×, 2.1×, and 1.5× on GPU, CPU, and ARM processors, respectively, while maintaining a 2.9% accuracy improvement on ImageNet-1k. The larger FasterNet-L achieves an impressive 83.5% top-1 accuracy, comparable to Swin-B, with a 49% higher inference throughput on GPU and a 42% reduction in compute time on CPU. Specifically, contributions provided by the present invention can be summarized as follows:
(1) emphasizing the importance of achieving higher FLOPS beyond merely reducing FLOPs for faster neural networks;
(2) introducing the PConv operator as a simple, fast, and effective alternative to the commonly used DWConv;
(3) presenting FasterNet, a high-speed network compatible with various devices, including GPU, CPU, and ARM processors; and
(4) conducting extensive experiments across different tasks to validate the speed and effectiveness of PConv and FasterNet.

### BRIEF DESCRIPTION OF DRAWINGS

Embodiments of the invention are described in more details hereinafter with reference to the drawings, in which:

FIG. 1 depicts a schematic diagram of designs with various convolution types, including the section (a) with regular convolution, the section (b) with depthwise/group convolution, and the section (c) with partial convolution according to one embodiment of the present invention;

FIG. 2 shows visualization of feature maps in an intermediate layer of a pre-trained ResNet50, with the top-left image as the input;

FIG. 3 depicts an architecture of the FasterNet which has four hierarchical stages according to one embodiment of the present invention;

FIG. 4 illustrates a comparison of convolutional variants, in which section (a) shows that a PConv followed by a PWConv is depicted; section (b) shows that the configuration resembles a T-shaped convolution, which spends more computational resources to the center position in contrast to a regular convolution, as represented in section (c);

FIG. 5 illustrates a histogram of salient position distribution for the regular Conv 3×3 filters in a pre-trained ResNet18;

FIG. 6 presents Table 1, illustrating on-device FLOPS for different operations according to one embodiment of the present invention;

FIG. 7 presents Table 2, illustrating configurations of different FasterNet variants according to one embodiment of the present invention;

FIG. 8 shows comparison of section (a) FLOPS vs. FLOPs on CPU and section (b) Latency vs. FLOPs according to one embodiment of the present invention;

FIG. 9 shows a schematic diagram of a device for employing an efficient neural network architecture through partial convolution in accordance with a first aspect of the present invention;

FIG. 10 shows a flowchart of processes of a method for employing an efficient neural network architecture through partial convolution in accordance with a second aspect of the present invention;

FIG. 11 presents Table 3, illustrating that PConv+PWConv achieve the lowest test loss;

FIG. 12 illustrates trade-off curves demonstrating the superiority of the FasterNet over state-of-the-art classification models;

FIG. 13 presents Table 4, illustrating comparison on ImageNet-1k benchmark according to one embodiment of the present invention;

FIG. 14 presents Table 5, illustrating results on COCO object detection and instance segmentation benchmarks according to one embodiment of the present invention;

FIG. 15 presents Table 6, illustrating ablation on the partial ratio, normalization, and activation of FasterNet according to one embodiment of the present invention;

FIG. 16 presents Table 7, illustrating ImageNet-1k training and evaluation settings for different FasterNet variants according to one embodiment of the present invention;

FIG. 17 presents Table 8, illustrating experimental settings of object detection and instance segmentation on the COCO2017 dataset according to one embodiment of the present invention;

FIG. 18 illustrates comparison of FasterNet with state-of-the-art networks according to one embodiment of the present invention; and

FIG. 19 presents Table 9, illustrating comparison of the two PConv implementations during inference.

### DETAILED DESCRIPTION OF THE INVENTION

In the following description, devices and methods for enhancing speed performance of AI neural networks by implementing an efficient neural network architecture with partial convolution and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the present disclosure, the prevalent network architectures with a primary focus on convolutional neural networks (CNNs) and the emerging interest in vision transformers (ViTs), multi-layer perceptrons (MLPs), and their variants are discussed first. CNNs are widely adopted for their efficiency, especially in mobile/edge-oriented networks like MobileNets, ShuffleNets, GhostNet, etc. However, they face challenges with increased memory access as network width grows to compensate for accuracy drop. In contrast, the proposed approach of the present invention considers redundancy in feature maps and introduces a partial convolution (PConv) to simultaneously reduce Floating-Point Operations (FLOPs) and memory access. The discussion extends to ViTs and MLPs, which have gained attention, with efforts to improve training settings and model design. Notably, there is a trend in pursuing an accuracy-latency trade-off in ViTs, involving modifications to the attention operator, incorporation of convolution, or a combination of both. Some studies propose replacing attention with MLP-based operators, although they tend to evolve into structures resembling CNNs.

In the neural network field, to design fast neural networks, substantial amount of works has been focusing on reducing the number of floating-point operations (FLOPs). However, it is observed that such reduction in FLOPs does not necessarily translate to a similar level of reduction in latency, primarily due to inefficiently low floating-point operations per second (FLOPS). In order to achieve faster networks, in the present disclosure, it is revisited that popular operators and demonstrated that low FLOPS is mainly attributed to frequent memory access of the operators, especially the depthwise convolution. As such, the present invention provides a novel partial convolution (PConv) that efficiently extracts spatial features by simultaneously reducing redundant computation and memory access. Building upon the PConv of the present invention, FasterNet can be further introduced, which is a new family of neural networks that achieves significantly higher running speed than others on a wide range of devices, without compromising accuracy for various vision tasks.

Before describing the mechanism of the PConv, it is first to revisit DWConv and analyze the issue with its frequent memory access. Then PConv is introduced as a competitive alternative operator to resolve the issue. Further, FasterNet is then introduced with explanation.

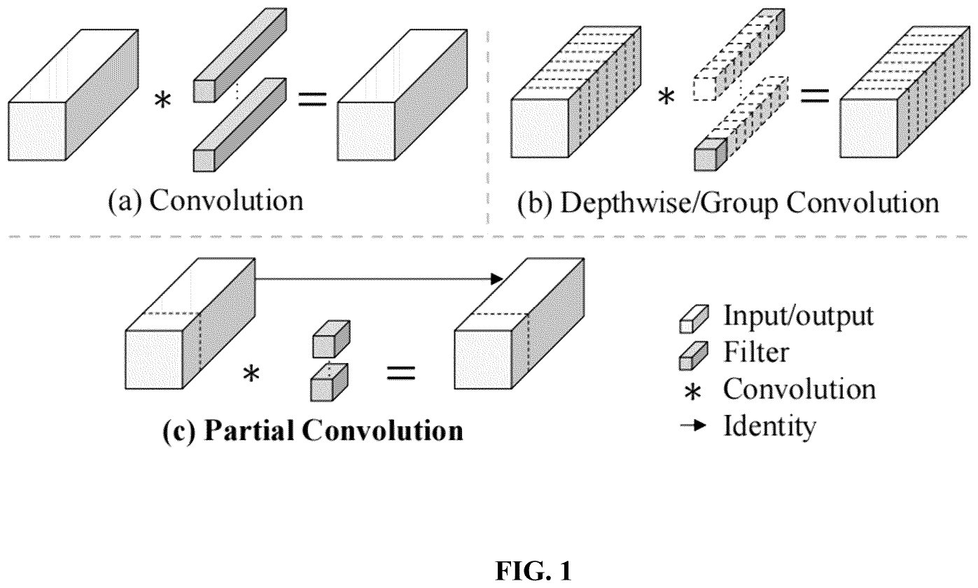

FIG. 1 depicts a schematic diagram of designs with various convolution types, including the section (a) with regular convolution, the section (b) with depthwise/group convolution, and the section (c) with partial convolution according to one embodiment of the present invention. DWConv is a popular variant of convolution (Conv) and has been widely adopted as a key building block for many neural networks. For an input I∈ [symbol] ^{c×h×ω}, DWConv applies c filters W∈ [symbol] ^{k×k}W to computation to the output O∈ [symbol] ^{c×h×ω}. As shown in the section (b) of FIG. 1, each filter slides spatially on one input channel and contributes to one output channel. This depthwise computation makes DWConv have as low FLOPs as h×ω×k²× c compared to a regular Conv with h×ω×k²×c². While effective in reducing FLOPs, a DWConv, which is typically followed by a pointwise convolution, or PWConv, cannot be simply used to replace a regular Conv as it would incur a severe accuracy drop. Thus, in practice, the channel number c (or the network width) of DWConv is required to increase to c′ (where, c′>c) to compensate the accuracy drop, e.g., the width is expanded by six times for the DWConv in the inverted bottleneck. This, however, results in much higher memory access that can cause nonnegligible delay and slow down the overall computation, especially for I/O-bound devices. In particular, the number of memory access now escalates to:

$$h \times ω \times 2 {c}^{′} + {k}^{2} \times c \approx h \times ω \times 2 {c}^{′} … \qquad ( 2 )$$

which is higher than that of a regular Conv, i.e.,

$$h \times ω \times 2 c + {k}^{2} \times {c}^{2} \approx h \times ω \times 2 c … \qquad ( 3 )$$

Note that the h×ω×2c′ memory access is spent on the I/O operation, which is deemed to be already the minimum cost and hard to optimize further.

The suitability of partial convolution as a fundamental operator is elucidated below.

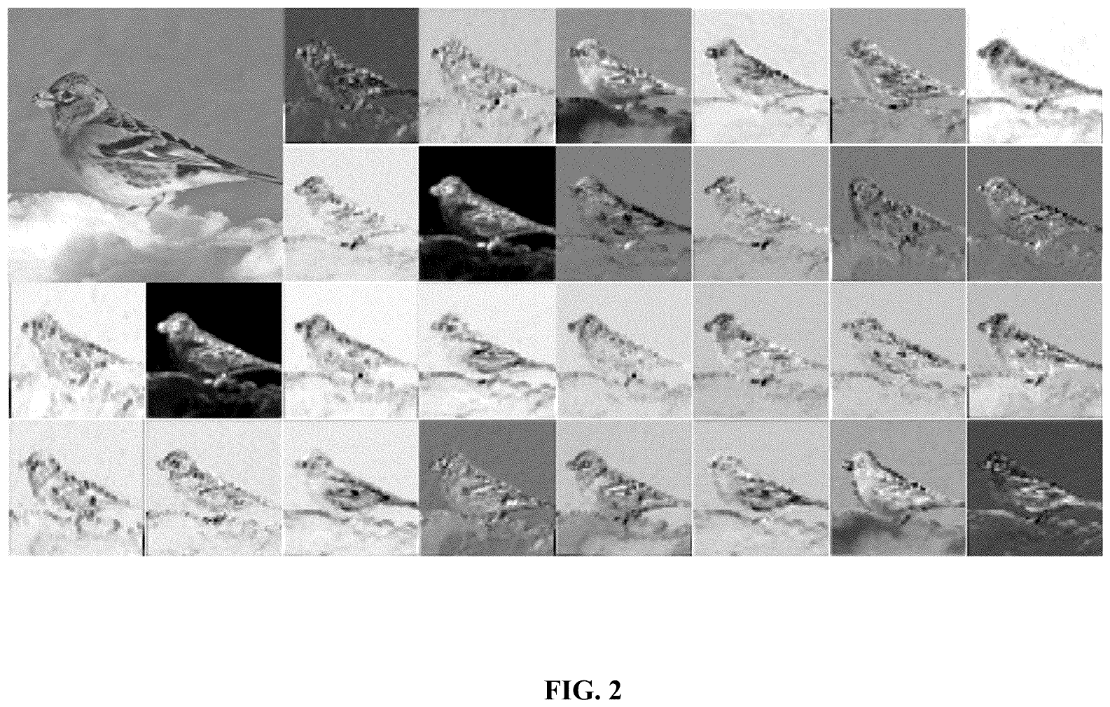

It is demonstrated that the cost can be further optimized by leveraging the feature maps' redundancy. As visualized, FIG. 2 shows visualization of feature maps in an intermediate layer of a pre-trained ResNet50, with the top-left image as the input. Qualitatively, it can be seen that the high redundancies across different channels; that is, the feature maps share high similarities among different channels. This redundancy has also been covered in many other works, but few of them make full use of it in a simple yet effective way.

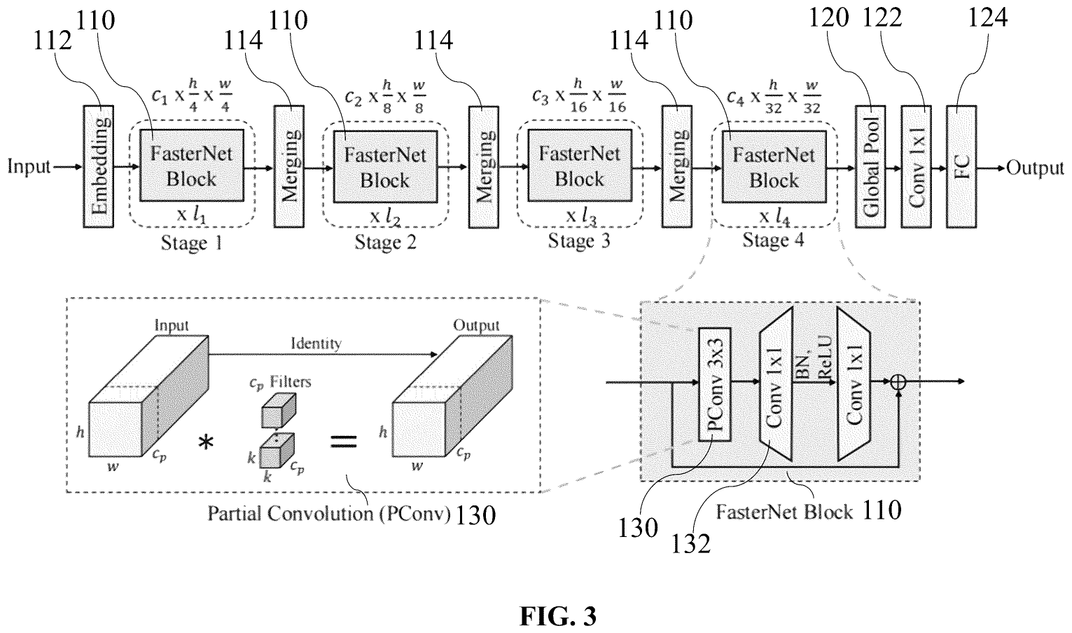

Specifically, in the present disclosure, a simple PConv is provided to reduce computational redundancy and memory access simultaneously. FIG. 3 depicts a schematic diagram of an overall architecture of a neural network with PConv according to one embodiment of the present invention. In the present disclosure, a neural network with PConv in its blocks can be called “FasterNet,” a new family of neural networks that run favorably fast and are highly effective for many vision tasks.

In the architecture of FIG. 3, the FasterNet has four hierarchical stages (i.e., Stage 1, Stage 2, Stage 3, Stage 4), each with a stack of FasterNet blocks 110 and preceded by at least one embedding layer 112 or at least one merging layer 114. The last three layers, global average pooling layer 120, a Conv 1×1 layer 122, and a fully-connected layer 124, are used for feature classification. Within each FasterNet block 110, a PConv layer 130 is followed by two pointwise convolution (PWConv) layers 132. Normalization and activation layers, such as BN layer and ReLU layer, are putted after the middle layer to preserve the feature diversity and achieve lower latency. The bottom-left corner in FIG. 3 illustrates how the PConv layer 130 works. It simply applies a regular Conv on only a part of the input channels for spatial feature extraction and leaves the remaining channels untouched. For contiguous or regular memory access, it is considered that the first or last consecutive cₚ channels as the representatives of the whole feature maps for computation. Without loss of generality, it is considered that the input and output feature maps to have the same number of channels. Therefore, the FLOPs of a PConv layer 130 is only:

$$h \times ω \times k \times {{c}_{p}}^{2} … \qquad ( 4 )$$

With a typical partial ratio

$$r = \frac{{c}_{p}}{c} = \frac{1}{4} ,$$

the FLOPs of a PConv layer 130 is only

$$\frac{1}{16}$$

of a regular Conv. Moreover, the PConv layer 130 has a smaller amount of memory access, i.e.,

$$h \times ω \times 2 {c}_{p} + {k}^{2} \times {{c}_{p}}^{2} \approx h \times ω \times 2 {c}_{p} … \qquad ( 5 )$$

which is only

$$\frac{1}{4}$$

of a regular Conv for

$$r = \frac{1}{4} .$$

Since there are only cₚ channels utilized for spatial feature extraction, if the remaining (c−cₚ) channels can be simply removed is an interesting issue. If so, PConv would degrade to a regular Conv with fewer channels, which is in contrast to the goal of the present invention to reduce redundancy. Note that the remaining channels is kept as untouched instead of removing them from the feature maps. It is because they are useful for a subsequent PWConv layer 132, which allows the feature information to flow through all channels.

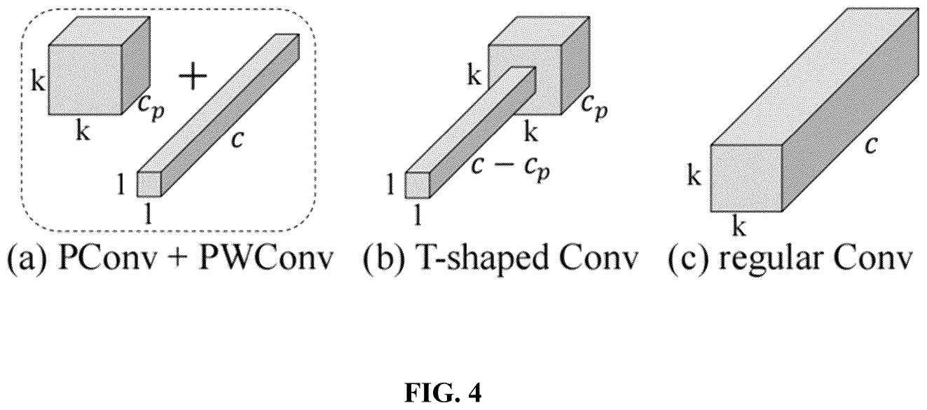

In one embodiment, to fully and efficiently leverage the information from all channels, at least one PWConv layer 132 is further appended to the PConv layer 130. FIG. 4 illustrates a comparison of convolutional variants, in which section (a) shows that a PConv followed by a PWConv is depicted; section (b) shows that the configuration resembles a T-shaped convolution, which spends more computational resources to the center position in contrast to a regular convolution, as represented in section (c). The effective receptive field of the PConv in combination with the PWConv on the input feature maps collectively looks like a T-shaped convolution, which focuses more on the center position compared to a regular convolution uniformly processing a patch. To justify this T-shaped receptive field, it is first to evaluate the importance of each position by calculating the position-wise Frobenius norm. It is to assume that a position tends to be more important if it has a larger Frobenius norm than other positions. For a regular Conv filter F∈ [symbol] ^{k}^{²}^{×c}, the Frobenius norm at position i is calculated by ∥Fᵢ∥=\sqrt{Σⱼ₌₁^{c}|fᵢⱼ|²}, for i=1, 2, 3 . . . , k². It is considered that a salient position to be the one with the maximum Frobenius norm. Then, examination to each filter in a pre-trained ResNet18 is performed collectively, finding out their salient positions and plotting a histogram of the salient positions.

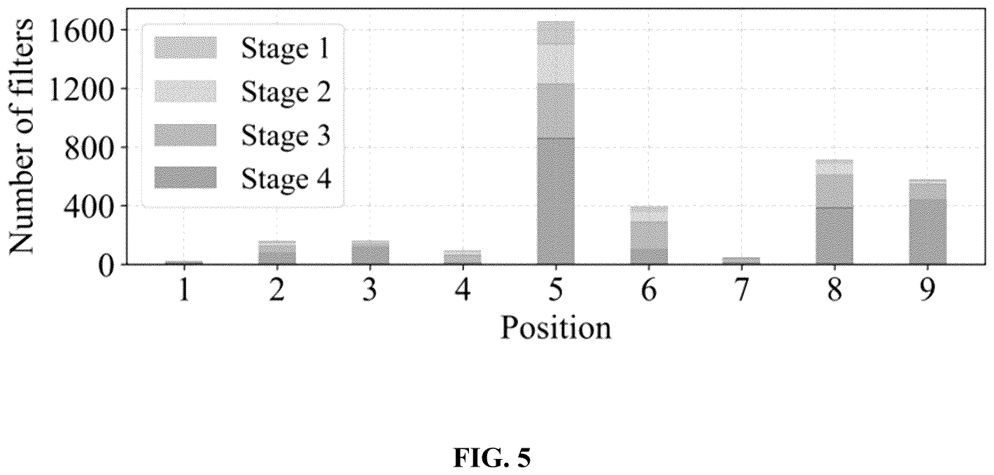

FIG. 5 illustrates a histogram of salient position distribution for the regular Conv 3×3 filters in a pre-trained ResNet18. The histogram contains four kinds of bars, corresponding to different stages in the network. In all stages, the center position (position 5) appears as a salient position most frequently. Results in FIG. 5 show that the center position turns out to be the salient position most frequently among the filters. In other words, the center position weighs more than its surrounding neighbors. This is consistent with the T-shaped computation, which concentrates on the center position. While the T-shaped Conv can be directly used for efficient computation, in an embodiment, it is to decompose the T-shaped Conv into a PConv and a PWConv because the decomposition exploits the inter-filter redundancy and further saves FLOPs.

For the same input I∈ [symbol] ^{c×h×w} and output O∈ [symbol] ^{c×h×w}, a T-shaped Conv's FLOPs can be calculated as:

$$h \times ω \times ( {k}^{2} \times {{c}_{p}}^{2} + c \times ( c - {c}_{p} ) ) … \qquad ( 6 )$$

which is much higher than the FLOPs of a PConv and a PWConv, i.e.,

$$h \times ω \times ( {k}^{2} \times {{c}_{p}}^{2} + c \times {c}_{p} ) … \qquad ( 6 )$$

where c>cₚ and c−cₚ>cₚ (e.g., when

$${c}_{p} = \frac{c}{4}$$

Furthermore, the regular Conv can be readily leveraged for the two-step implementation.

More features regarding the FasterNet, which can serve as a general backbone, are provided below. Given the provided novel PConv and off-the-shelf PWConv as the primary building operators, FasterNet can be constituted as new family of neural networks that run favorably fast and are highly effective for many vision tasks. It aims to keep the architecture as simple as possible, without bells and whistles, to make it hardware-friendly and universally applicable to various platforms.

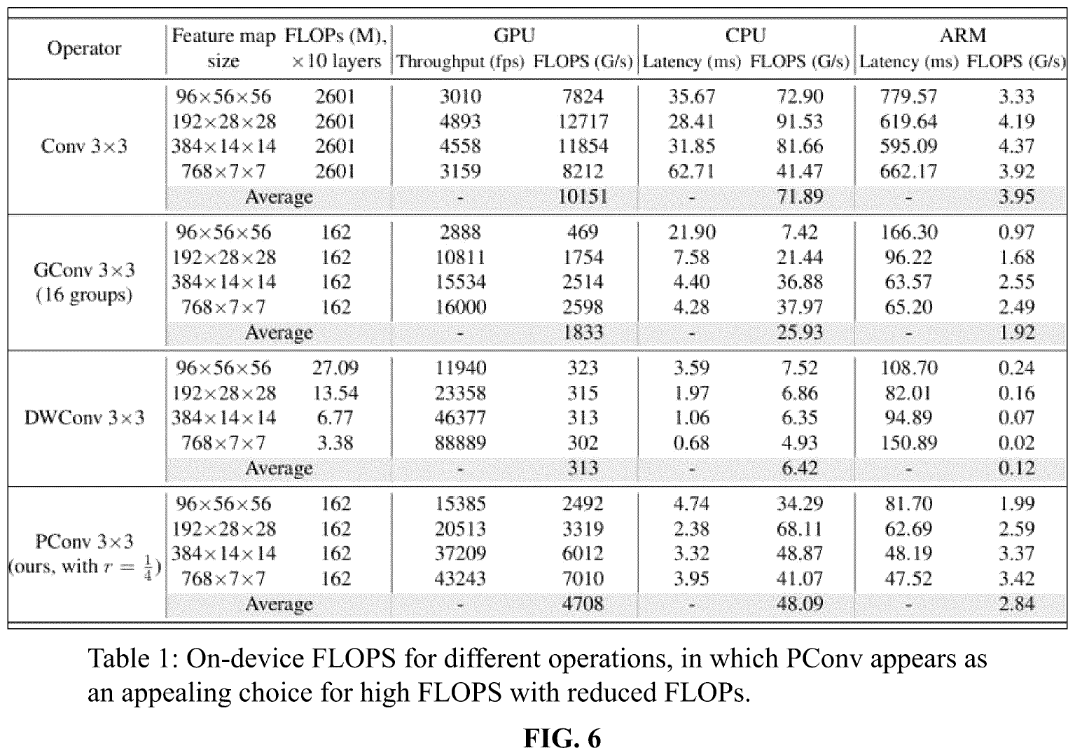

Referring back to FIG. 3, the overall architecture for the FasterNet has four hierarchical stages, each of which is preceded by an embedding layer (a regular Conv 4×4 with stride 4) or a merging layer (a regular Conv 2×2 with stride 2) for spatial downsampling and channel number expanding. Each stage has a stack of FasterNet blocks 110. It can be observed that the blocks 110 in the last two stages consume less memory access and tend to have higher FLOPS, as empirically validated in Table 1 of FIG. 6. Thus, more FasterNet blocks 110 are putted and more computations are correspondingly assigned to the last two stages. Each FasterNet block 110 has a PConv layer 130 followed by two PWConv (or Conv 1×1) layers 132. Together, they appear in an inverted residual bottleneck structure where the middle layer has an expanded number of channels, and a shortcut connection is placed to reuse the input features.

In addition to the above operators, in one embodiment, the normalization and activation layers are also indispensable for high-performing neural networks. Many prior works, however, overuse such layers throughout the network, which may limit the feature diversity and thus hurt the performance. It may also slow down the overall computation. By contrast, they are only putted after each middle PWConv to preserve the feature diversity and achieve lower latency. Moreover, the batch normalization (BN) is applied instead of other alternative ones. The benefit of BN is that it can be merged into its adjacent Conv layers for faster inference while being as effective as the others. As for the activation layers, GELU is chosen for smaller FasterNet variants and ReLU is chosen for bigger FasterNet variants, considering both running time and effectiveness. The last three layers, i.e., a global average pooling, a Conv 1×1, and a fully-connected layer, are used together for feature transformation and classification.

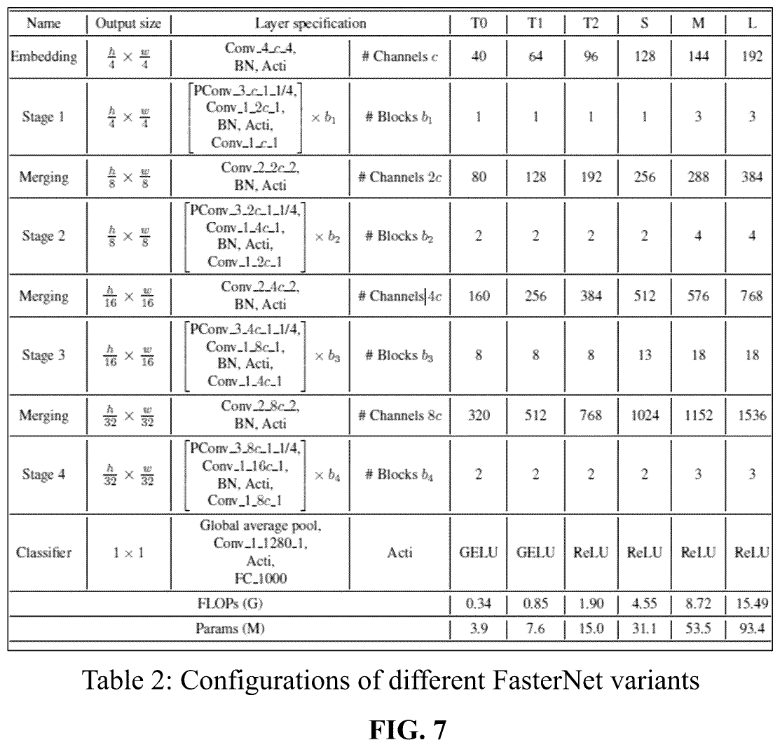

To serve a wide range of applications under different computational budgets, tiny, small, medium, and large variants of FasterNet are provided, referred to as FasterNet-T0/1/2, FasterNet-S, FasterNet-M, and FasterNet-L, respectively. They share a similar architecture but vary in depth and width. Detailed architecture specifications are provided in Table 2 of FIG. 7, in which “Conv_k_c_s” means a convolutional layer with the kernel size of k, the output channels of c, and the stride of s. “PConv_k_c_s_r” means a partial convolution with an extra parameter, the partial ratio of r. “FC 1000” means a fully connected layer with 1000 output channels. h×w is the input size while bi is the number of FasterNet blocks at stage i. The FLOPs are calculated given the input size of 224×224.

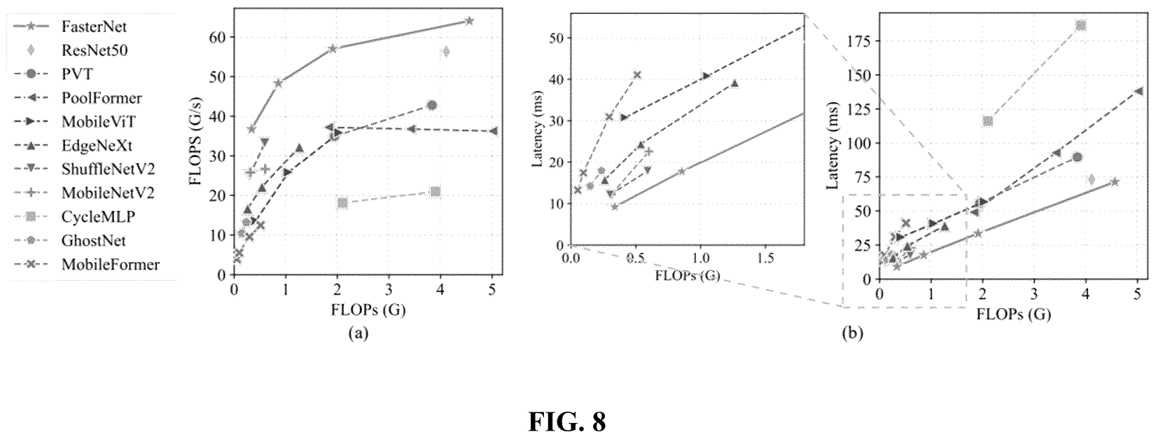

FIG. 8 shows comparison of section (a) FLOPS vs. FLOPs on CPU; and section (b) Latency vs. FLOPs according to one embodiment of the present invention. The results reveal that many existing neural networks suffer from low FLOPS, and their FLOPS are generally lower than the popular ResNet50. With such low FLOPS, these so-called “fast” neural networks are not actually fast enough. Their reduction in FLOPS cannot be accurately translated into a corresponding reduction in latency. In some cases, there is no improvement, and it may even lead to worse latency. For instance, CycleMLP-B1 has half the FLOPs of ResNet50 but runs more slowly (i.e., CycleMLP-B1 vs. ResNet50: 111.9 ms vs. 69.4 ms). Note that this discrepancy between FLOPs and latency has also been observed in previous works but remains unresolved, partially because they employ DWConv/GConv and various data manipulations with low FLOPS. In this regard, by contrast, the FasterNet provided by the present invention maintains higher FLOPS and obtains lower latency than others with the same amount of FLOPs.

In accordance with various embodiments of the present disclosure, the FasterNet containing the FasterNet blocks with PConv and PWConv are integrated in a module (e.g., a fast network module) and executed by one or more computer processors or electronic circuits capable of executing logics or machine instructions.

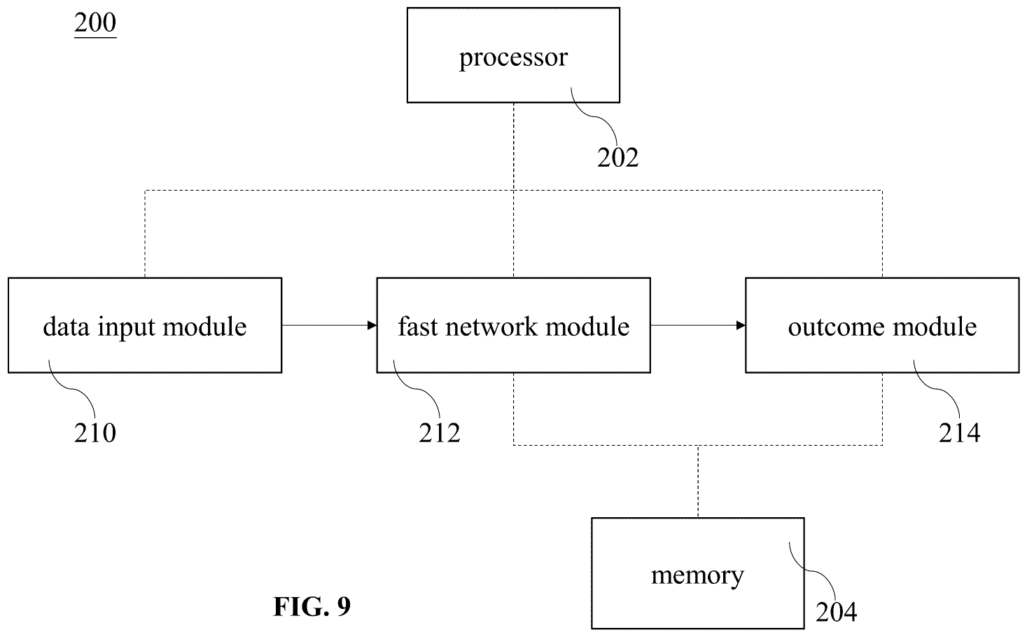

FIG. 9 shows a schematic diagram of a device 200 for employing an efficient neural network architecture through partial convolution in accordance with a first aspect of the present invention. The device 200 can execute a method for classification tasks, such as image classification, object detection, image segmentation, embedded device applications, real-time visual applications. For image classification: FasterNet is utilized as the foundational architecture for image classification tasks to achieve faster inference speeds across various devices while maintaining high classification accuracy. For object detection: FasterNet can be applied to object detection models, aiming for improved real-time performance. Its rapid operators and overall structure contribute to achieving lower latency in visual applications. For image segmentation: FasterNet is applied to image segmentation tasks to attain faster and more efficient image segmentation results. This is particularly beneficial for applications requiring real-time feedback, such as autonomous driving or real-time image processing. For embedded device applications: as considering FasterNet's lightweight design and high efficiency, it may be particularly suitable for embedded devices, such as smart cameras, smartphones, and IoT devices. For real-time visual applications: the fast inference capabilities of FasterNet make it an ideal choice for applications requiring real-time visual processing, such as augmented reality applications and real-time gaming.

The device 200 includes a processor 202, a memory 204, a data input module 210, a fast network module 212, and an outcome module 214, in which the processor 202 can execute operating procedures among the modules and between the memory 204 and the fast network module 212.

In this regard, the FasterNet is integrated into a comprehensive module as the fast network module 212 to implement the operations/processes as afore-described. The data input module 210 is responsible for loading and providing input data to the fast network module 212. The fast network module 212 processes these input data using operations such as FasterNet blocks with PConv layers and PWConv layers, generating corresponding outputs. Finally, the outcome module 214 receives the results generated by the fast network module 212 for further processing or storage. For example, the results of the fast network module 212 (e.g., the output of the fully connected layer) can be stored or recorded. Such results are typically used to assess the model/module's performance, generate classification reports, or make subsequent decisions in applications. In one embodiment, the results generated by the fast network module 212 can be converted by the outcome module 214 and transmitted to the memory 204 for storage. These results can be recorded in a program-readable file for reference or further analysis. For example, this file may include the predicted class for each input image, corresponding scores or probabilities, and other relevant evaluation metrics. These results can be used to evaluate the model's performance, conduct subsequent optimizations, or serve as logs in the application.

This modular structure allows for more flexible integration and application, making the entire architecture more manageable and scalable.

In one embodiment, the output of the fully connected layer (e.g., the fully connected layer 124 of FIG. 3) is a vector containing scores for different classes. Each element represents the model's confidence or score for a specific class. The class scores in this vector can be interpreted as the model's confidence levels for each class in determining the input image. In one embodiment, the output of the fully connected layer (e.g., the fully connected layer 124 of FIG. 3) may be a probability distribution. The class with the highest probability is often considered the model's predicted result. Such predictions are usually represented by a class label, indicating the class the model believes the input belongs to. For example, these prediction results can be considered as the model's classification outcomes for a given input image. For multi-class classification tasks, there may be probability scores for multiple classes, while for binary classification, there are typically probabilities for two classes (e.g., positive and negative).

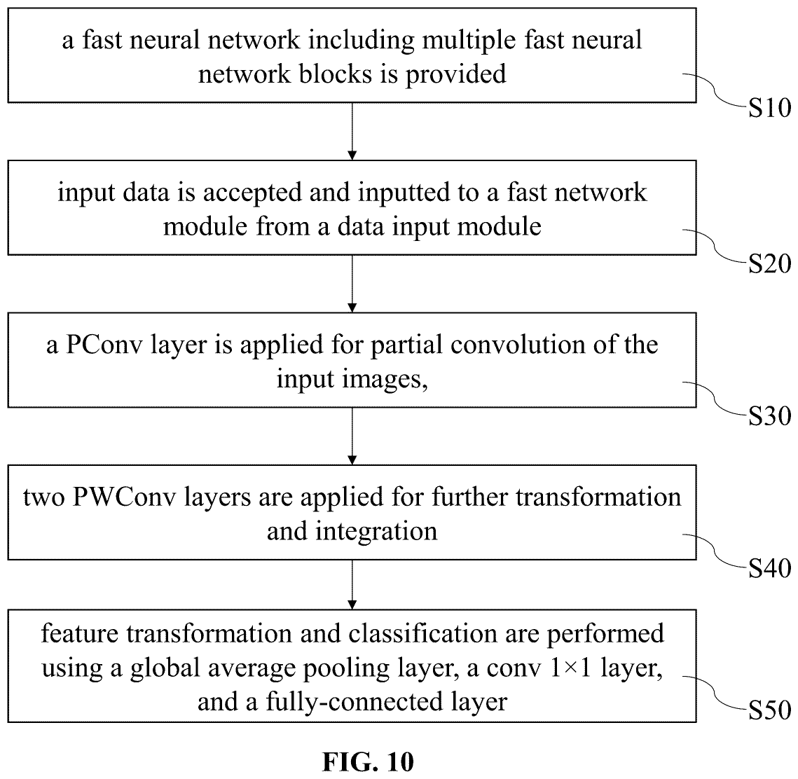

FIG. 10 shows a flowchart of processes of a method for employing an efficient neural network architecture through partial convolution in accordance with a second aspect of the present invention. The method can be executed or implemented by the device 200 as shown in FIG. 9 and includes steps S10-S50. In the steps illustrated in FIG. 10, image classification is used as an example and does not limit the present invention. However, in other embodiments, the method for employing the FasterNet architecture can also be used to perform other types of classification tasks.

In the step S10, a fast neural network, namely the FasterNet, including multiple fast neural network blocks is provided as a fast network module 212, in which each fast neural network block includes a single PConv (i.e., partial convolution) layer and two PWConv (i.e., pointwise convolution) layers.

In the step S20, input data is accepted and input to the fast network module 212 from a data input module 210, in which the input data can be one or more images and each image contains pixel values and class labels.

In the step S30, in each fast neural network block, a PConv layer is applied for partial convolution of the input data (e.g., input images), achieving standard convolution operations on partial channels while preserving other channels unaffected. In one embodiment, the PConv layer selectively convolves only a portion of input channels by leveraging redundant information in feature maps, ensuring efficient feature extraction and contributing to reduced computational redundancy and optimized memory usage. Such the selective convolution operation can be adjusted based on the structure and content of the feature map for more effective computation. Herein, the term “feature maps” may refer to the spatial and channel-wise representations of intermediate data within the neural network.

In the step S40, in each fast neural network block, the two PWConv layers are applied subsequently, and each of the PWConv layers uses a 1×1 convolutional kernel, for further transformation and integration of features output from the PConv layer. In one embodiment, the two PWConv layers following the PConv layer form an inverted residual bottleneck structure, and a shortcut connection is placed to reuse input features. In one embodiment, a batch normalization (BN) layer and an activation layer are putted between the PWConv layers to preserve the feature diversity and achieve lower latency (see FIG. 3). In some embodiments, the choice between Gaussian error linear unit (GELU) and rectified linear unit (ReLU) depends on the size of the fast neural network variant in the fast neural network block, with GELU being chosen for smaller variants and ReLU being chosen for larger variants within the fast neural network in the fast neural network block.

In the step S50, feature transformation and classification are performed using a global average pooling layer, a conv 1×1 layer, and a fully-connected layer collectively. Specifically, the step S50 may include: employing the global average pooling layer (e.g., global average pooling layer 120 of FIG. 3) for average operations on each feature map, capturing global information in the image; connecting a Conv 1×1 layer (e.g., Conv 1×1 layer 122 of FIG. 3) for further transformation and refinement of features, so as to retain important features in the image; and using the fully connected layer (e.g., fully connected layer 124 of FIG. 3) to map the processed features to the final classification labels, such that the output of the fully connected layer is the result of image classification. After the step S50, the outcome of the fast neural network blocks is processed through connection and integration to form an overall output of image classification, and then classification labels representing predicted class of the input image are outputted from the fast network module 212 to the outcome module 214.

Next, illustrative experimental results are provided. The first examine is made to the computational speed of PConv provided by the present invention and its effectiveness when combined to a PWConv, as afroed-mentioned. Then, it is to comprehensively evaluate the performance of the FasterNet provided by the present invention for classification, detection, and segmentation tasks. Finally, a brief ablation study is conducted. To benchmark the latency and throughput, the following three typical processors are chosen, which cover a wide range of computational capacity: GPU (2080Ti), CPU (Intel i9-9900X, using a single thread), and ARM (Cortex-A72, using a single thread). The report is about their latency for inputs with a batch size of 1 and throughput for inputs with a batch size of 32. During inference, the BN layers are merged to their adjacent layers wherever applicable.

This passage is made to demonstrate the PConv is fast with high FLOPS and better exploits the on-device computational capacity. 10 layers of pure PConv are stacked and feature maps of typical dimensions are taken as inputs. FLOPs and latency/throughput on GPU, CPU, and ARM processors are measured, which also enable computation to FLOPS. The same procedure for other convolutional variants is repeated and comparisons are further made. Referring back to Table 1 of FIG. 6, the results show that PConv is overall an appealing choice for high FLOPS with reduced FLOPs. It has only

$$\frac{1}{16}$$

FLOPs of a regular Conv and achieves 14×, 6.5×, and 22.7× higher FLOPS than the DWConv on GPU, CPU, and ARM, respectively. It can be found that the regular Conv has the highest FLOPS as it has been constantly optimized for years. However, its total FLOPs and latency/throughput are unaffordable. GConv and DWConv, despite their significant reduction in FLOPs, suffer from a drastic decrease in FLOPS. In addition, they tend to increase the number of channels to compensate for the performance drop, which, however, increase their latency.

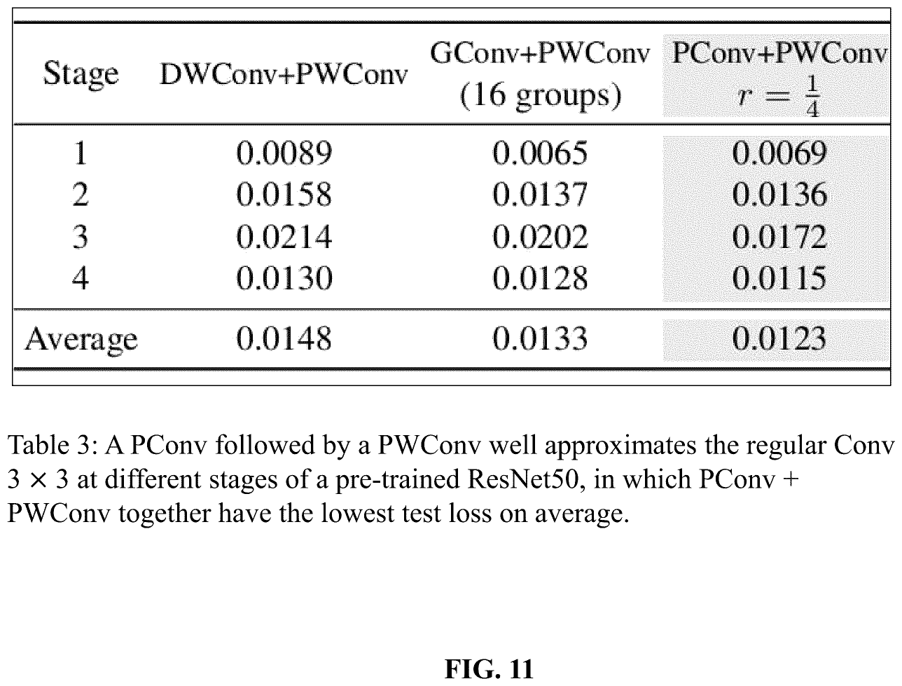

The next demonstration is a configuration of a PConv followed by a PWConv, which is effective in approximating a regular Conv to transform the feature maps. To this end, four datasets are built by feeding the ImageNet-1k val split images into a pre-trained ResNet50, and the feature maps are extracted before and after the first Conv 3×3 in each of the four stages. Each feature map dataset is further spilt into the train (70%), val (10%), and test (20%) subsets. Then, a simple network consisting of a PConv followed by a PWConv is built and is trained on the feature map datasets with a mean squared error loss. For comparison, networks for DWConv+PWConv and GConv+PWConv are built and trained under the same setting as well. Table 3 of FIG. 11 shows that PConv+PWConv achieve the lowest test loss, meaning that they better approximate a regular Conv in feature transformation. The results also suggest that it is sufficient and efficient to capture spatial features from only a part of the feature maps. PConv shows a great potential to be the new go-to choice in designing fast and effective neural networks.

To verify the effectiveness and efficiency of the Faster-Net provided by the present invention, experiments on the large-scale ImageNet-1k classification dataset are first conducted. It covers 1k categories of common objects and contains about 1.3M labeled images for training and 50 k labeled images for validation. The models are trained for 300 epochs using AdamW optimizer. The batch size is set to 2048 for the FasterNet-M/L and 4096 for other variants. Cosine learning rate scheduler is used with a peak value of 0.001-batch size/1024 and a 20-epoch linear warmup. Commonly-used regularization and augmentation techniques are applied, including Weight Decay, Stochastic Depth, Label Smoothing, Mixup, Cutmix and Rand Augment, with varying magnitudes for different FasterNet variant s. To reduce the training time, 192×192 resolution is used for the first 280 training epochs and 224×224 is used for the remaining 20 epochs. For fair comparison, knowledge distillation and neural architecture search are not used herein. The report shows top-1 accuracy on the validation set with a center crop at 224×224 resolution and a 0.9 crop ratio.

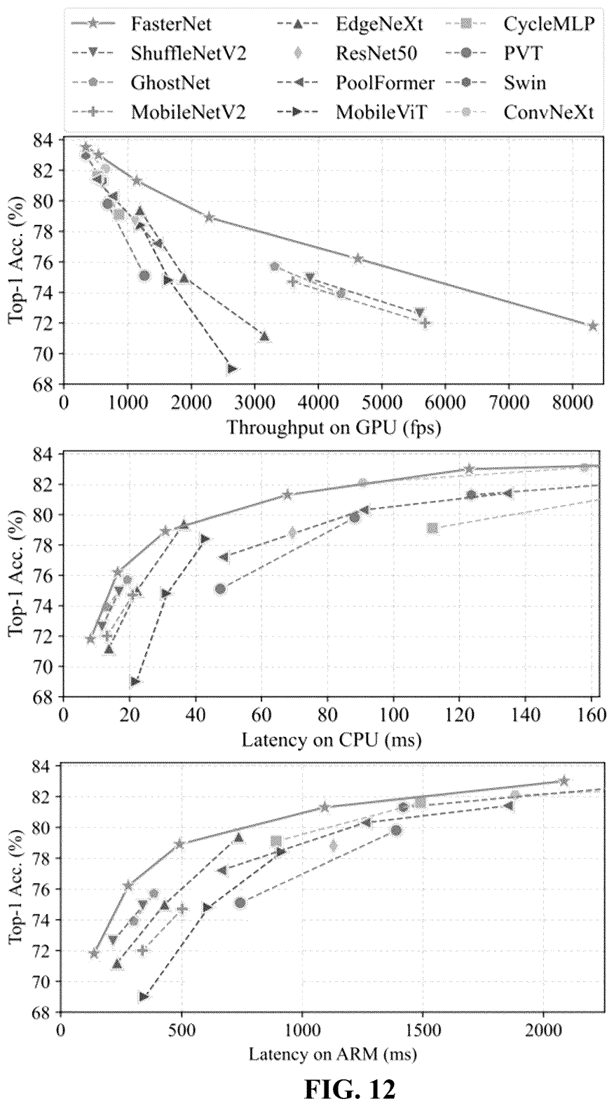

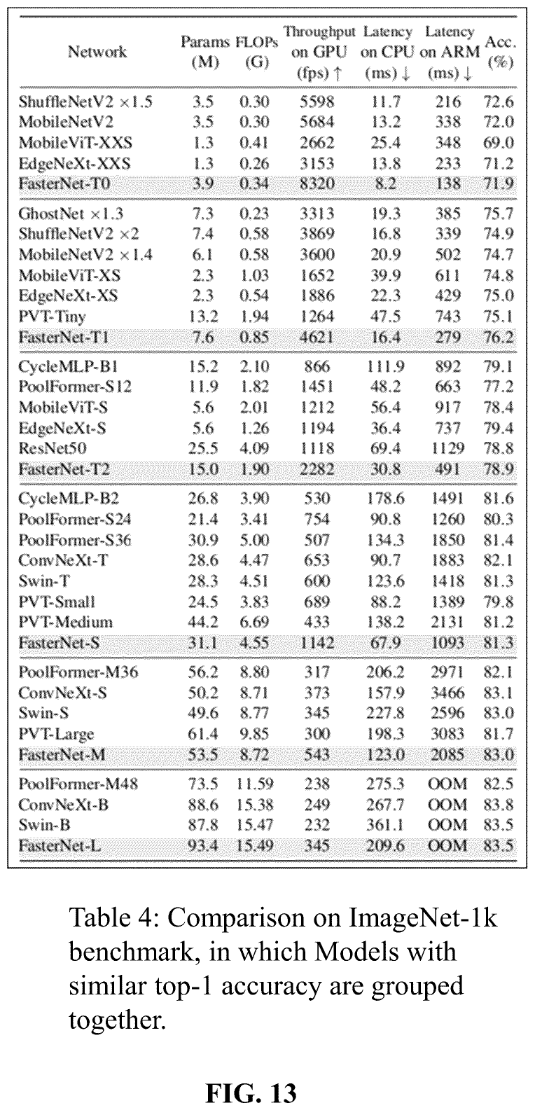

FIG. 12 and Table 4 of FIG. 13 demonstrate the superiority of our FasterNet over state-of-the-art classification models. The trade-off curves in FIG. 12 clearly show that FasterNet sets the new state-of-the-art in balancing accuracy vs. latency/throughput among all the networks examined. From another perspective, FasterNet runs faster than various CNN, ViT and MLP models on a wide range of devices, when having similar top-1 accuracy. As quantitatively shown in Table 3 of FIG. 11, FasterNet-T0 is 2.1×, 2.1×, and 1.5× faster than (3.1×, 3.1×, and 2.5× as fast as) MobileViT-XXS on GPU, CPU, and ARM processors, respectively, while being 2.9% more accurate. The large FasterNet-L provided by the present invention achieves 83.5% top-1 accuracy, comparable to the emerging Swin-B and ConvNeXt-B while having 49% and 39% higher inference throughput on GPU, as well as saving 42% and 22% compute time on CPU. Given such promising results, it is highlighted that FasterNet provided by the present invention is much simpler than many other models in terms of architectural design, which showcases the feasibility of designing simple yet powerful neural networks. Furthermore, for each group, the FasterNet provided by the present invention achieves the highest throughput on GPU and the lowest latency on CPU and ARM. All models are evaluated at 224×224 resolution except for the MobileViT and EdgeNeXt with 256×256. OOM is short for out of memory.

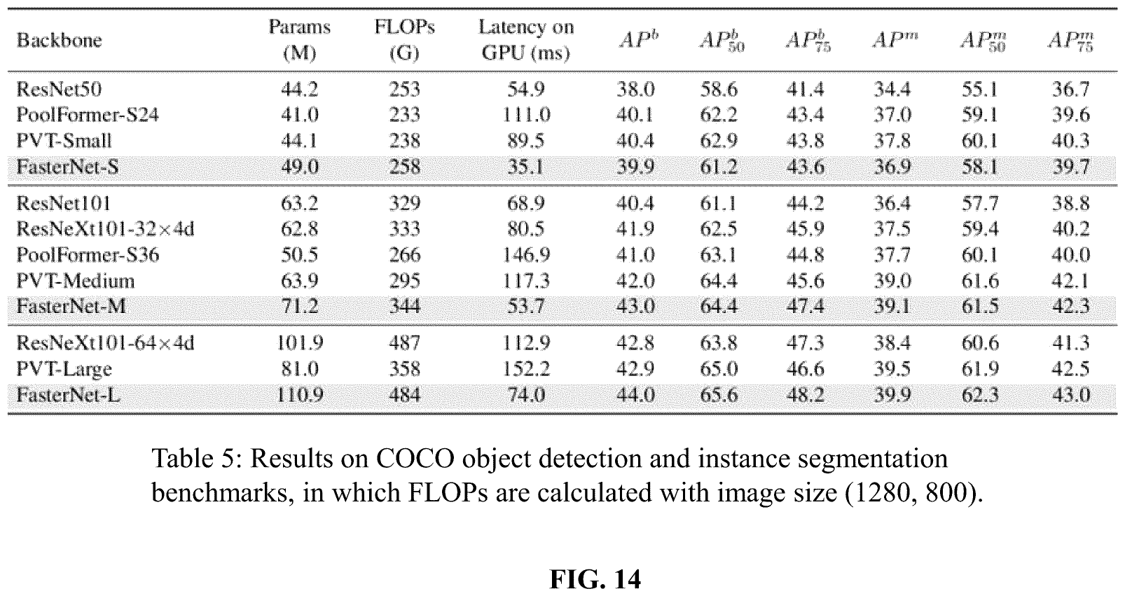

Regarding the FasterNet on downstream tasks, to further evaluate the generalization ability of the Faster-Net, experiments are conducted on the challenging COCO dataset for object detection and instance segmentation. As a common practice, the ImageNet pre-trained FasterNet is employed as a backbone and equip it with the popular Mask R-CNN detector. To highlight the effectiveness of the backbone itself, the experiments simply follow Pool-Former and adopt an AdamW optimizer, a 1×training schedule (12 epochs), a batch size of 16, and other training settings without further hyper-parameter tuning. Table 5 of FIG. 14 shows the results for comparison between FasterNet and representative models. FasterNet consistently outperforms ResNet and ResNext by having lower latency and higher average precision (AP). Specifically, FasterNet-S saves 36% compute time and yields +1.9 higher box AP and +2.4 higher mask AP compared to the standard baseline ResNet50. FasterNet is also competitive against the ViT variants. Under similar FLOPs, FasterNet-L reduces PVT-Large's latency by half, i.e., from 152 ms to 74 ms on GPU, and achieves +1.1 higher box AP and +0.4 higher mask AP.

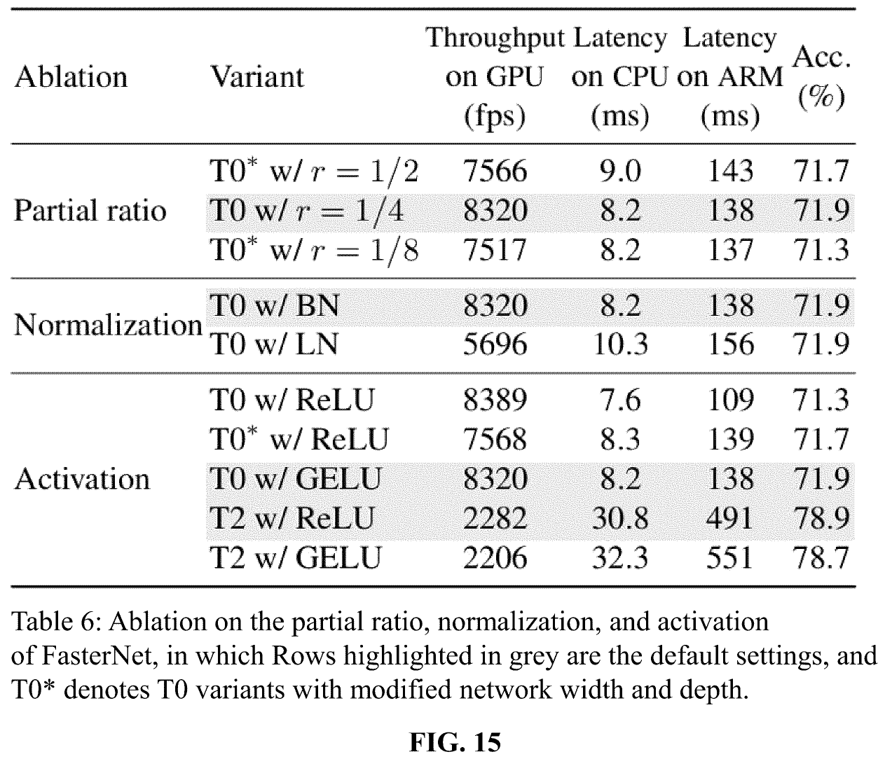

A brief ablation study is conducted on the value of partial ratio r and the choices of activation and normalization layers. Different variants are compared in terms of ImageNet top-1 accuracy and on-device latency/throughput. Results are summarized in Table 6 of FIG. 15. For the partial ratio r, it is set to 14 for all FasterNet variants by default, which consistently achieves higher accuracy, higher throughput, and lower latency at similar complexity. A too large partial ratio r would make PConv degrade to a regular Conv, while a too small value would render PConv less effective in capturing the spatial features. For the normalization layers, BatchNorm is chosen over LayerNorm because BatchNorm can be merged into its adjacent convolutional layers for faster inference while it is as effective as LayerNorm in the provided experiment. For the activation function, interestingly, it is empirically found that GELU fits FasterNet-T0/T1 models more efficiently than ReLU. It, however, becomes opposite for FasterNet-T2/S/M/L. Herein, only two examples are shown in Table 6 of FIG. 15 due to space constraint. It can be conjectured that GELU strengthens FasterNet-T0/T1 by having higher non-linearity, while the benefit fades away for larger variants.

The appendix as follows is provided further details on the experimental settings, full comparison plots, architectural configurations, PConv implementations, limitations, training and validation settings or other additional information.

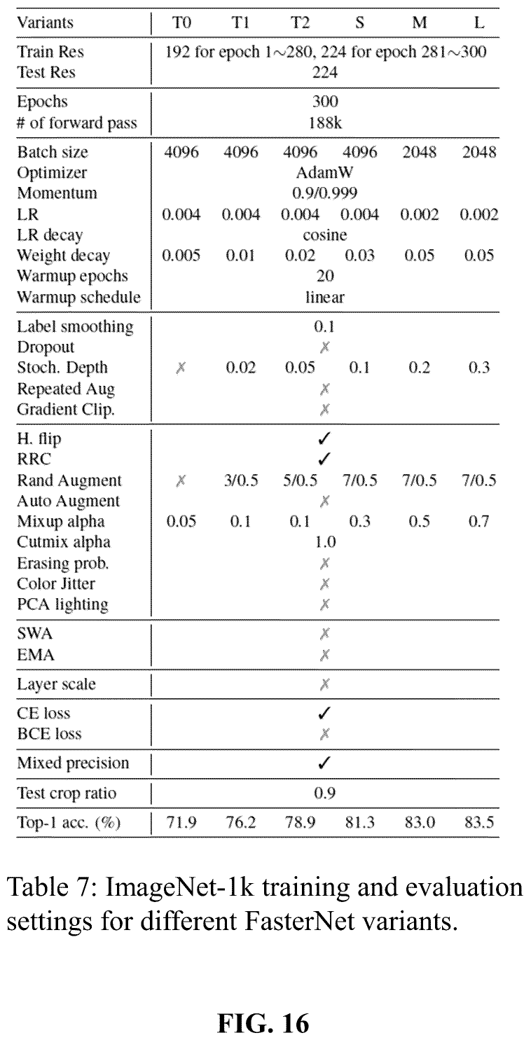

(A) Regarding ImageNet-1k experimental settings, the provided is ImageNet-1k training and evaluation settings in Table 7 of FIG. 16. They can be used for reproducing the main results in FIG. 12 and Table 4 of FIG. 13. Different FasterNet variants vary in the magnitude of regularization and augmentation techniques. The magnitude increases as the model becomes larger to alleviate overfitting and improve accuracy.

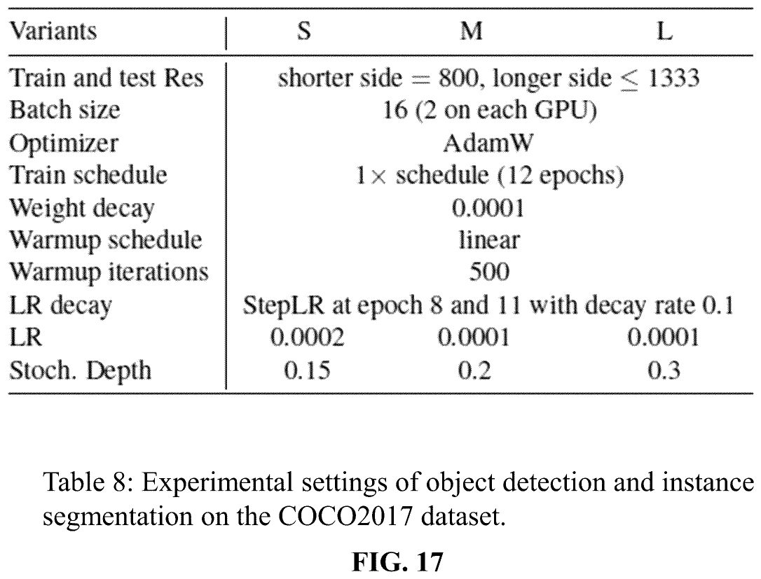

(B) Regarding downstream tasks experimental settings, for object detection and instance segmentation on the COCO2017 dataset, the FasterNet backbone is equipped with the popular Mask R-CNN detector. ImageNet-1k pre-trained weights is used to initialize the backbone and Xavier to initialize the add-on layers. Detailed settings are summarized in Table 8 of FIG. 17.

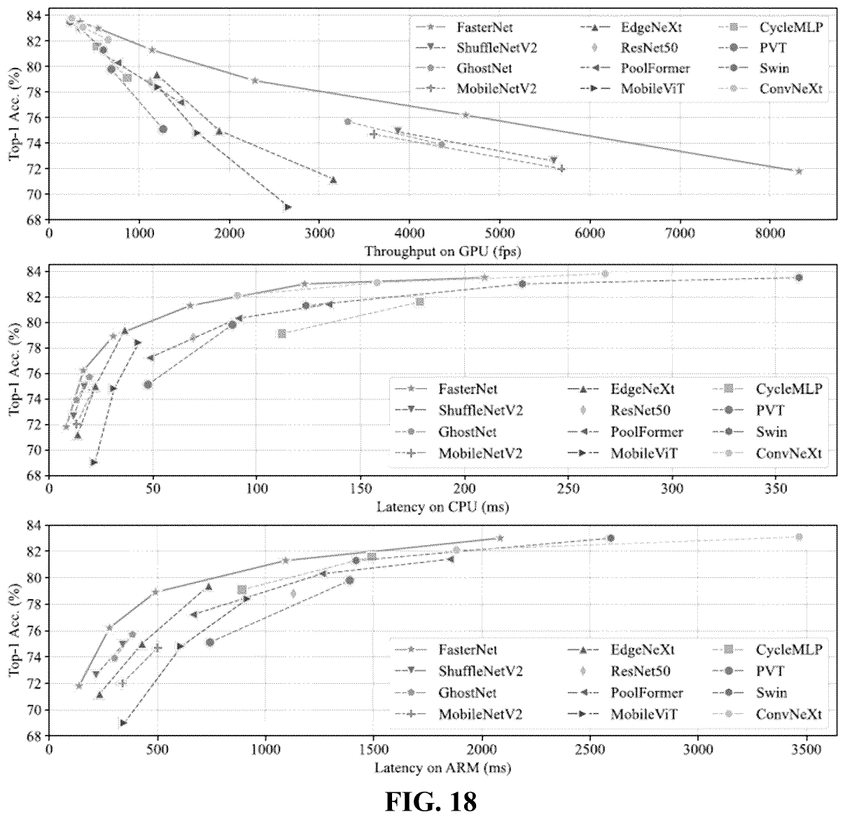

(C) Regarding full comparison plots on ImageNet-1k, FIG. 18 shows the full comparison plots on ImageNet-1k, which is the extension of FIG. 10 in the main paper with a larger range of latency. FIG. 16 shows consistent results that FasterNet strikes better trade-offs than others in balancing accuracy and latency/throughput on GPU, CPU, and ARM processors.

(D) Regarding detailed architectural configurations, the present information is the detailed architectural configurations in Table 2 of FIG. 7. While different FasterNet variants share a unified architecture, they vary in the network width (the number of channels) and network depth (the number of FasterNet blocks at each stage). The classifier at the end of the architecture is used for classification tasks but removed for other downstream tasks.

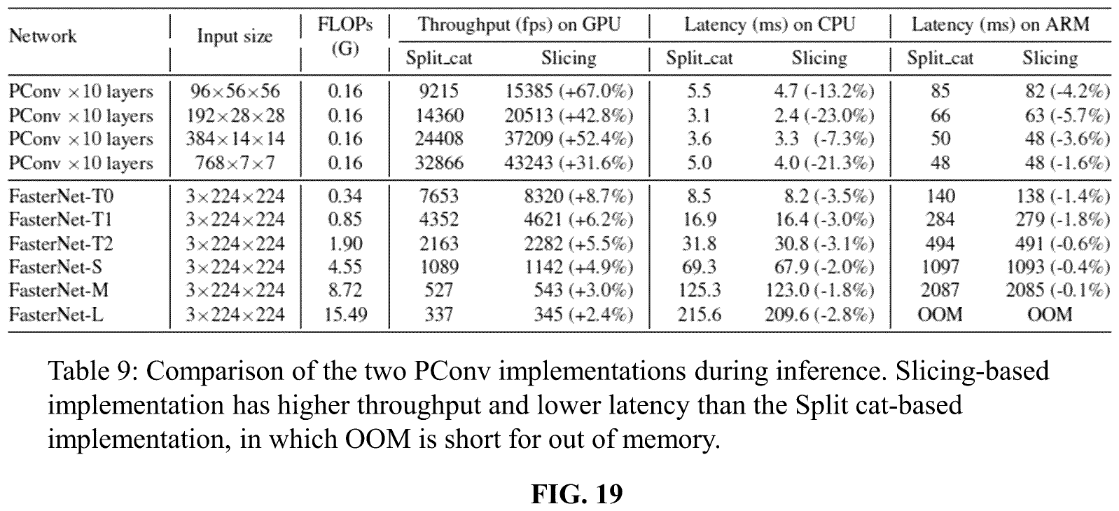

(E) Regarding implementation of PConv, the PyTorch-based implementation of PConv is provided in Table 9 of FIG. 19. There are two forward pass choices, namely forward slicing and forward split cat. The forward slicing choice writes the convolutional output in place of the input, which is used for faster inference, but not for training, as the in-place operation modifies the gradient computation. By contrast, the forward split cat choice concatenates the convolutional output with the feature maps untouched, which preserves the intermediate gradient computation and is used for training. Table 9 of FIG. 19 shows the speed comparison of these.

In the present disclosure, the common and unresolved issue of low floating-point operations per second (FLOPS) in many established neural networks has been investigated. A bottleneck operator, DWConv, is revisited, and its main cause for a slowdown-frequent memory access is analyzed. To overcome this issue and achieve faster neural networks, a simple yet fast and effective operator, PConv, has been proposed, which can be readily plugged into many existing networks. The general-purpose FasterNet, built upon PConv, has been introduced, achieving a state-of-the-art speed and accuracy trade-off on various devices and vision tasks.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A device for enhancing speed performance artificial intelligence neural networks by implementing a neural network architecture with partial convolution, comprising:
a fast network module, wherein a fast neural network comprising multiple fast neural network blocks with at least one partial convolution (PConv) layer and at least two pointwise convolution (PWConv) layers are integrated in the fast network module;
a data input module responsible for loading and providing input data to the fast network module, wherein the PConv layer in each of the fast neural network blocks is applied for partial convolution of the input data with achieving standard convolution operations on partial channels while preserving other channels unaffected and selectively convolves only a portion of input channels by leveraging redundant information in feature maps, and wherein the two PWConv layers following the PConv layer in each of the fast neural network blocks are configured to transform and integrate features output from the PConv layer; and
an outcome module configured to receive results generated by the fast network module for storage or record.

2. The device of claim 1, wherein the two PWConv layers following the PConv layer in each of the fast neural network blocks form an inverted residual bottleneck structure, and a shortcut connection is placed to reuse input features.

3. The device of claim 2, wherein the fast network module further comprises at least one batch normalization (BN) layer and at least one activation layer putted between the PWConv layers in each of the fast neural network blocks.

4. The device of claim 3, wherein, based on size of a fast neural network variant within the fast neural network block, a Gaussian error linear unit (GELU) is selected for smaller variants in the fast neural network block as the activation layer.

5. The device of claim 3, wherein, based on size of a fast neural network variant within the fast neural network block, a rectified linear unit (ReLU) is selected for larger variants in the fast neural network block as the activation layer.

6. The device of claim 1, wherein the fast neural network has four hierarchical stages defined by the fast neural network blocks, respectively, and further comprises an embedding layer preceding the first one of the hierarchical stages and three merging layers among the other three of the hierarchical stages.

7. The device of claim 6, further comprising a global average pooling layer, a Conv 1×1 layer, and a fully-connected layer which are subsequently connected from the fourth one of the hierarchical stages to the outcome module for feature classification.

8. The device of claim 1, wherein an effective receptive field resulting from a combination of the single PConv layer and the two PWConv layers resembles a T-shaped convolution.

9. The device of claim 1, wherein the input data comprises one or more images and each image contains pixel values and class labels, and the results generated by the fast network module are related to a classification task.

10. The device of claim 1, wherein the results generated by the fast network module are processed by the outcome module, and subsequently transmitted to a memory where they are stored as a program-readable file, functioning as comprehensive logs for further analysis and reference.

11. An enhancing speed performance artificial intelligence neural networks by implementing a neural network architecture with partial convolution, comprising:
loading and providing input data, by a data input module, to a fast network module, wherein the fast neural network comprises multiple fast neural network blocks with at least one partial convolution (PConv) layer and at least two pointwise convolution (PWConv) layers;
applying the PConv layer in each of the fast neural network blocks for partial convolution of the input data with achieving standard convolution operations on partial channels while preserving other channels unaffected, which comprises selectively convolving only a portion of input channels by leveraging redundant information in feature maps using the PConv layer;
transforming and integrating features output from the PConv layer by using the two PWConv layers following the PConv layer in each of the fast neural network blocks;
receiving, by an outcome module, results generated by the fast network module for storage or record.

12. The method of claim 11, wherein the two PWConv layers following the PConv layer in each of the fast neural network blocks form an inverted residual bottleneck structure, and a shortcut connection is placed to reuse input features.

13. The method of claim 12, wherein the fast network module further comprises at least one batch normalization (BN) layer and at least one activation layer putted between the PWConv layers in each of the fast neural network blocks.

14. The method of claim 13, further comprising: selecting a Gaussian error linear unit (GELU) for smaller variants in the fast neural network block as the activation layer, based on size of a fast neural network variant within the fast neural network block.

15. The method of claim 13, further comprising: selecting a rectified linear unit (ReLU) for larger variants in the fast neural network block as the activation layer, based on size of a fast neural network variant within the fast neural network block.

16. The method of claim 11, wherein the fast neural network has four hierarchical stages defined by the fast neural network blocks, respectively, and further comprises an embedding layer preceding the first one of the hierarchical stages and three merging layers among the other three of the hierarchical stages.

17. The method of claim 16, further comprising a global average pooling layer, a Conv 1×1 layer, and a fully-connected layer which are subsequently connected from the fourth one of the hierarchical stages to the outcome module for feature classification.

18. The device of claim 11, wherein an effective receptive field resulting from a combination of the single PConv layer and the two PWConv layers resembles a T-shaped convolution.

19. The method of claim 11, wherein the input data comprises one or more images and each image contains pixel values and class labels, and the results generated by the fast network module are related to a classification task.

20. The method of claim 11, further comprising:
processing and subsequently transmitting, by the outcome module, the results generated by the fast network module to a memory where they are stored as a program-readable file and function as comprehensive logs for further analysis and reference.
